(19) United States
(12) Patent Application Publication
(10) Pub. No.: US 2018/0128219 A1
(43) Pub. Date: May 10, 2018

(54) FUEL SUPPLY MODULE FOR COMBUSTION ENGINE AND VEHICLE HAVING THE SAME

(71) Applicants: Hyundai Motor Europe Technical Center GmbH, Russelsheim (DE); HYUNDAI MOTOR COMPANY, Seoul (KR); KIA MOTORS CORPORATION, Seoul (KR)

(72) Inventors: Andreas KAPP, Eschborn (DE); Stephan FITZNER, Langen (DE)

(21) Appl. No.: 15/373,079

(22) Filed: Dec. 8, 2016

(30) Foreign Application Priority Data
Nov. 7, 2016 (DE) 102016221709.7

(51) Int. Cl. F02M 37/00; F02M 37/04; F02M 37/22; F02M 63/02; F02D 41/38

(52) U.S. Cl. CPC F02M 37/0052; F02M 37/0035; F02D 41/3827; F02M 37/22; F02M 63/0265; F02M 37/04

(57) ABSTRACT

A fuel supply module for a combustion engine includes a low pressure fuel pump, a fuel filter and a high pressure fuel pump. The low pressure fuel pump, the fuel filter and the high pressure fuel pump are integral parts of the fuel supply module and the fuel filter is arranged between the low pressure fuel pump and the high pressure fuel pump.

### CROSS-REFERENCE(S) TO RELATED APPLICATION

This application claims the benefit of priority to German Patent Application No. 102016221709.7, filed on Nov. 7, 2016, which is incorporated herein by reference in its entirety.

### TECHNICAL FIELD

The present disclosure relates to fuel supply module for combustion engine, in particular, a diesel engine, and a vehicle having the fuel supply module.

### BACKGROUND

Typically, a layout of a diesel system comprises in particular following components: a fuel tank, a low pressure pump, at least one supply line to a fuel filter, the fuel filter, and at least one further line to a high pressure pump. An electrical fuel heater is typically arranged in front of the fuel filter. In addition, a combustion engine comprises high pressure parts such as a rail, in particular a common rail, with injectors. The combustion engine is driven by the fuel stored in the fuel tank which passes typically through a low pressure fuel arrangement.

In general, in the low pressure fuel arrangement, fuel from the fuel tank is pumped via the low pressure pump in conjunction with the supply line to the fuel filter. The fuel filter filters the fuel of the fuel tank at any time, whereby the electrical fuel heater heats up the fuel at cold temperatures.

When the fuel has passed the fuel filter, it is guided to the high pressure pump. A certain amount of fuel is then in particular further pressurized in the high pressure pump. The precise pressurized amount can be controlled by a metering unit. Generally, a bigger amount of the fuel is not pressurized but used for cooling and lubricating the high pressure pump. This fuel can be returned or back-guided to the fuel tank via a first fuel return line and subsequently a main fuel return line, wherein the pressurized fuel is supplied to the rail, for example, a common rail. The pressurized fuel is then supplied to injectors of the corresponding combustion engine. However, not all of the pressurized fuel guided to rail ends up in the combustion chamber. To realize and control a precise rail pressure, a pressure control valve of the rail blows up fuel to the main fuel return line via a second fuel return line in case the desired fuel pressure in the rail is lower than a detected actual pressure.

The above-mentioned injectors typically required a certain amount of fuel to operate a servo since diesel injectors are neither solenoid nor piezo injectors. In other words, an actuation of the injectors can be in particular realized by a servo circle only. This servo circle is generally driven by fuel, meaning a certain amount of fuel is needed to operate the injectors and thereby discharged to a return flow of the injectors. Both fuel amounts from the servo of the injectors and from the pressure control valve are configured to lead to the main fuel return line of the low pressure fuel arrangement back to the fuel tank. This entire backflow via in particular the main fuel return line is much hotter than fuel via the supply line from the fuel tank in particular caused by the pressurization and friction of the high pressure pump.

The low pressure fuel arrangement further comprises wires for power supply. These wires are required to be connected with in particular the low pressure pump. In particular, at least three, in general application, five wires, are typically laid within a vehicle to be connected with the low pressure pump. These wires are typically laid from an engine compartment in the front of the vehicle to the fuel tank in the back of the vehicle. Therefore, wires with a length between typically two to six meters are required.

The fuel filter is typically equipped with an electrical fuel heater to prevent the fuel filter from blocking during cold operation or cold start since for example diesel leans to segregate paraffin within the fuel filter whereby the paraffin can block the fuel filter which can results in engine stalling or no engine operation.

The electrical fuel heater typically requires electrical power which can influence an overall efficiency of the vehicle. Despite the efficiency of the electrical fuel heater and its energy consumption, the electrical fuel heater furthermore needs further power supply lines with large cross section caused by high ampere running through the power supply lines. The power supply lines are typically made of expensive copper.

Beside the power supply lines, an electrical relay is needed to activate the electrical fuel heater.

Furthermore, the typical common rail system needs the above mentioned metering unit to control the fuel pressure in the rail. This metering unit is an expensive and has complex parts.

Consequently, there is a need to further improve the low pressure fuel arrangement. Thus, there is a fuel supply module needed which is in particular energy efficient and cost-saving.

### SUMMARY

According to an exemplary embodiment of the present disclosure, a fuel supply module for a combustion engine, e.g., in a diesel combustion engine, includes: a low pressure pump; a fuel filter; and a high pressure pump. The low pressure pump, the fuel filter, and the high pressure pump are integral parts of the fuel supply module and the fuel filter is arranged between the low pressure pump and the high pressure pump.

Under the term “integral” it should be understood that the low pressure pump, the fuel filter and the high pressure pump are essential components of the module. In other words, the fuel supply module can be a stand-alone module, wherein each of its components is essential for its functionality. The low pressure pump of the fuel supply system can be arranged to the high pressure pump such that the low pressure pump and the high pressure pump are in particular separated by the fuel filter, wherein a distance between the low pressure pump and high pressure pump can be defined by a width or lateral extent of the fuel filter. In other words, the low pressure pump and the high pressure pump can be arranged close to each other within the fuel supply module to ensure a precise and quick control of a fuel metering via the low pressure pump.

The fuel supply module can be an autonomous module.

According to another exemplary embodiment of the present disclosure, a vehicle having a fuel supply module which includes: a low pressure pump; a fuel filter; and a high pressure pump. The low pressure pump, the fuel filter, and the high pressure pump are integral parts of the fuel supply module and the fuel filter is arranged between the low pressure pump and the high pressure pump.

An aspect of the present disclosure is to provide a fuel supply module whereby an improved fuel recirculation and CO₂ reduction can be obtained.

According to the exemplary embodiment of the present disclosure, by implementing the fuel supply module a metering unit of the high pressure pump can be avoided since the fuel supply module provides an improved fuel metering concept via the low pressure pump. By avoiding the metering unit of the high pressure pump a further cost benefit can be realized. The fuel metering can be realized by controlling the low pressure pump.

Further, by implementing the fuel supply module an electrical fuel heater and its power supply lines can be avoided by integral relocation of the low pressure pump within the fuel supply module.

The fuel supply module may be mounted in an engine compartment.

The engine compartment comprises in particular a combustion engine. By implementing the fuel supply module, power supply lines made of copper between the low pressure pump located in the fuel tank in the back of the vehicle and the engine compartment can be avoided.

The low pressure pump may be connected with a fuel tank via a supply line.

The fuel filter and the high pressure pump may be also connected with the supply line. With the above-described fuel supply module, the low pressure pump can be mounted, arranged, or positioned in the engine compartment, and therefore, a power supply via power supply lines can be realized in an easy and cost-saving manner. That is, the low pressure pump is not located or positioned with the fuel tank and therefore a complex and cost-intensive connection with power supply lines can be avoided.

The high pressure pump may be connected with a main fuel return line via a first fuel return line and the main fuel return line is connected with the fuel tank.

Therefore, the fuel for cooling and lubricating the high pressure pump can be easily guided to the main fuel return line via the first fuel return line.

A recirculation line with a recirculation valve may be arranged between the supply line and the main fuel return line and the recirculation line is arranged ahead of the low pressure pump.

For example, a heat-up of the fuel can be managed within the engine compartment via the combustion engine and in conjunction with the recirculation line with the recirculation valve. An operation of the recirculation line with the recirculation valve in the dependence with the fuel temperature can be used to supply the fuel filter with heated-up fuel, e.g. after engine start, via the low pressure pump. Therefore, the set-up of a fuel supply layout can be easily improved. That is, by using the here described fuel supply module, an electrical fuel heater can be eliminated which results in further cost and energy saving.

The recirculation valve may be controllable in conjunction with a fuel temperature.

Thus, the fuel supply module can be driven in an energy saving manner.

The recirculation valve may be closed at the fuel temperature above 40° C. or the recirculation valve may be opened at the fuel temperature equal or below 40° C.

With the fuel supply module as described above, the fuel can be heated-up by the combustion engine, and therefore, the electrical fuel heater can be avoided. During normal operation of the combustion engine, the fuel temperature can be above 40° C. At cold start, the above-described fuel supply module can quickly heat-up the fuel within the engine compartment, in particular, within the combustion engine, such that the combustion engine can be started without using the electrical fuel heater.

The high pressure pump may be connected with a rail via a high pressure line.

In a common rail system, fuel is distributed to the injectors from a high pressure accumulator, called the rail. The rail is fed by the high pressure pump, also called high pressure fuel pump. The pressure in the rail, as well as start and end of an activation signal for each cylinder are electronically controlled. Therefore, by using the fuel supply module the metering unit in the high pressure pump can be avoided.

The rail may comprise a second fuel return line and the second fuel return line is connected with the main fuel return line.

Thus, the non-combusted fuel in the rail can be easily guided to the main fuel return line from a pressure control valve of the rail using the second fuel return line.

At least one injector may be connected with the main fuel return line via a third fuel return line.

Thus, non-combusted fuel in the injectors can be easily guided to the main fuel return line via the third fuel return line.

The first fuel return line, the second fuel return line and the third fuel return line lead to the main fuel return line.

By implementing or mounting the fuel supply module in the engine compartment the first fuel return line, the second fuel return line and the third fuel return line can be easily connected with the main fuel return line.

The here described features for the fuel supply module are also disclosed for the vehicle with the fuel supply module and vice versa.

### BRIEF DESCRIPTION OF THE DRAWINGS

FIG. 1 a schematic view of a low pressure fuel arrangement according to the prior art;

FIG. 2 a schematic view of a low pressure fuel arrangement based on FIG. 1 according to the prior art;

FIG. 3 a schematic view of a fuel supply module according to a first embodiment of the present disclosure;

FIG. 4 a schematic view of a fuel supply module according to a second embodiment of the present disclosure; and

FIG. 5 a schematic cross-sectional view of a vehicle with a fuel supply module according to FIG. 3 or FIG. 4.

Unless indicated otherwise, like reference numbers to the figures indicate like elements.

### DETAILED DESCRIPTION OF THE EMBODIMENTS

In the figures, a fuel direction is indicated by the arrows within the corresponding supply line 4 and fuel return lines 10, 12, 13, 14.

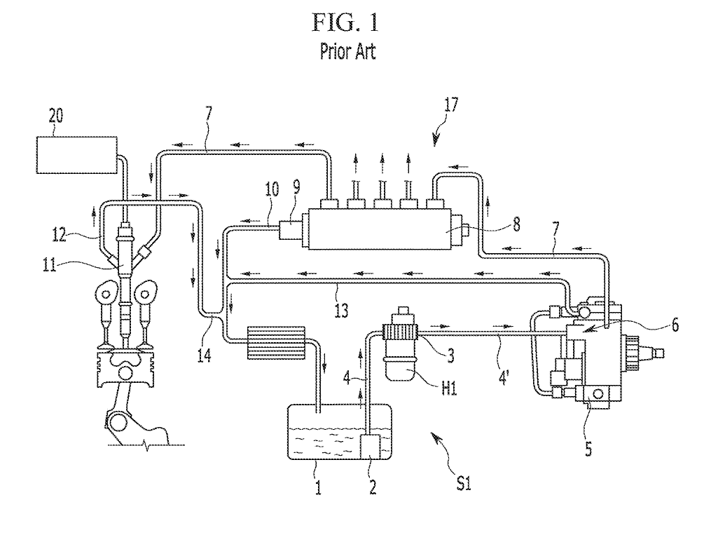

FIG. 1 illustrates a schematic view of a low pressure fuel arrangement according to the prior art.

FIG. 1 illustrates a layout of an engine system, in particular, a diesel system. The diesel system comprises: a fuel tank 1, a low pressure pump 2, at least one supply line 4 to a fuel filter 3, the fuel filter 3 and at least one further supply line 4′ to a high pressure pump 5. The low pressure pump 2 is located within the fuel tank 1 and the low pressure pump 2 is connected with an engine compartment EC1 via power supply lines made for example of copper. An electrical fuel heater H1 is typically arranged in front of the fuel filter 3. A combustion engine 17 of the engine compartment EC1 comprises high pressure parts, such as a rail 8, in particular, a common rail with injectors 11. The combustion engine 17 is driven by fuel stored in the fuel tank 1 which passes through a low pressure fuel arrangement S1.

Typically, in the low pressure fuel arrangement S1, fuel from the fuel tank 1 is pumped via the low pressure pump 2 in conjunction with the supply line 4 to the fuel filter 3. The fuel filter 3 filters the fuel of the fuel tank at any time, whereby the electrical fuel heater H1 heats-up the fuel at cold temperatures.

When the fuel has passed the fuel filter 3, it is guided to the high pressure pump 5. A certain amount of fuel is then further pressurized in the high pressure pump 5. The precise pressurized amount can be e.g. controlled by a metering unit 6. However, a bigger amount of fuel cannot be pressurized but merely used for cooling and lubricating the high pressure pump 5. This fuel returns to the fuel tank 1 via a first fuel return line 13 and subsequently a main fuel return line 14, wherein the pressurized fuel is supplied to the rail 8, for example, the common rail. The pressurized fuel is then supplied to the injectors 11 of the corresponding combustion engine 17. But, not all of the pressurized fuel guided to the rail 8 ends up in the combustion chamber of the combustion engine 17. To realize and control a precise rail pressure, a pressure control valve 9 of the rail 8 blows up the fuel to the main fuel return line 14 via a second fuel return line 10 in case the desired fuel pressure in the rail is lower than a detected actual pressure.

The above-mentioned injectors 11 having an electronic control unit (ECU) 20 typically need a certain amount of fuel to operate a servo since the diesel injectors are neither solenoid nor piezo injectors for direct acting. In other words, an actuation of the injectors 11 can be realized by a servo circle. This servo circle is generally driven by fuel, that is, a certain amount of fuel is needed to operate the injectors 11 and thereby discharged to a return flow of the injectors. Both fuel amounts from the servo of the injectors 11 and from the pressure control valve 9 lead to the main fuel return line 14 of the low pressure fuel arrangement S1 back to the fuel tank 1. This entire backflow via the main fuel return line 14 is hotter than a flow via the supply line 4 from the fuel tank 1, in particular, caused by the pressurization and friction of the high pressure fuel pump 5.

The low pressure fuel arrangement S1 further comprises wires (not shown) for power supply. These wires are required to be connected with in particular the low pressure fuel pump 2. For example, at least three, in general application, five wires, are typically laid within a vehicle A1 to be connected to the low pressure fuel pump 2. These wires are typically laid from an engine compartment EC1 in the front of the vehicle A1 to the fuel tank 1 in the back of the vehicle A1. Therefore, wires with a length between typically two to six meters are required.

The fuel filter 3 is typically equipped with an electrical fuel heater H1 to prevent the fuel filter 3 from blocking during cold operation or cold start since for example diesel leans to segregate paraffin within the fuel filter 3 whereby the paraffin can block the fuel filter 3 which can results in engine stalling or no engine operation.

Furthermore, a typical common rail system needs the metering unit 6 to control the fuel pressure in the rail 8. This metering unit 6 is usually an expensive part.

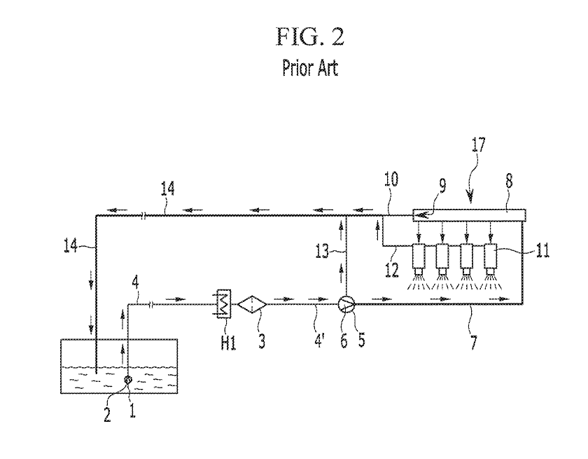

FIG. 2 illustrates a schematic view of a low pressure fuel arrangement based on FIG. 1 according to the prior art.

FIG. 2 illustrates a simplified schematic view of FIG. 1 and is substantially based on FIG. 1 with the difference that the electrical fuel heater H1 of the fuel filter 3 is separately shown to illustrate in particular a difference between the low pressure fuel arrangement S1 and a fuel supply module M1 of the present disclosure.

The electrical fuel heater H1 typically requires electrical power which can influence an overall efficiency of the vehicle A1. Despite the efficiency of the electrical fuel heater H1 and its energy consumption, the electrical fuel heater H1 furthermore needs power supply lines with large cross section caused by high ampere running through the power supply lines. The power supply lines are typically made of expensive copper.

As can be seen in FIGS. 1 and 2, the low pressure fuel pump 2 is arranged, located, or positioned in the fuel tank 1. The fuel tank 1 is typically arranged, located, or positioned in the back of the vehicle A1.

Beside the power supply lines, an electrical relay is needed to activate the electrical fuel heater H1.

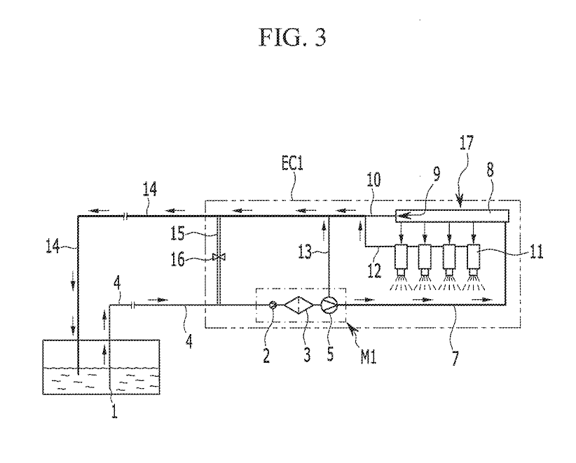

FIG. 3 illustrates a schematic view of a fuel supply module according to a first embodiment of the present disclosure.

Reference sign M1 illustrates the fuel supply module. The fuel supply module M1 for a combustion engine 17, in particular, a diesel combustion engine, comprises a low pressure fuel pump 2, fuel filter 3, and a high pressure fuel pump 5. The low pressure fuel pump 2, the fuel filter 3, and the high pressure fuel pump 5 are integral parts of the fuel supply module M1. The fuel filter 3 is arranged between the low pressure fuel pump 2 and the high pressure fuel pump 5.

The fuel supply module M1 can be mounted, arranged, or installed in an engine compartment EC1. The engine compartment EC1 comprises the combustion engine 17.

The low pressure fuel pump 2 and the high pressure fuel pump 5 can be located, arranged, or positioned close to each other substantially separated by the fuel filter 3 within the fuel supply module M1 to ensure a precise and quick control of a fuel metering via the low pressure fuel pump 2 of the fuel supply module M1.

The low pressure fuel pump 2 is connected with the fuel tank 1 via a supply line 4. The high pressure fuel pump 5 is connected with a main fuel return line 14 via a first fuel return line 13, and the main fuel return line 14 is connected with the fuel tank 1.

In other words, the low pressure fuel pump 2 is not any more arranged, located, or positioned in the fuel tank 1 as shown in FIG. 1 and FIG. 2.

The fuel supply module M1 comprises a recirculation line 15 with a recirculation valve 16. The recirculation line 15 is arranged between the supply line 4 and the main fuel return line 14, and the recirculation line 15 is arranged in front of the low pressure fuel pump 2.

The fuel supply module M1 is supplied with fuel, and the fuel is heated up by the combustion engine 17. The high pressure fuel pump 5 is connected with a rail 8 via a high pressure line 7. The rail 8 comprises a second fuel return line 10 and the second fuel return line 10 is connected with the main fuel return line 14. The injectors 11 are connected with the main fuel return line 14 via a third fuel return line 12. The first fuel return line 13, the second fuel return line 10 and the third fuel return line 12 lead to the main fuel return line 14.

FIG. 3 shows the fuel supply module M1 during normal operation, which in particular can be a fuel temperature above 40° C. Under this condition, the recirculation valve 16 of the recirculation line 15 remains closed. During this state, the low pressure fuel pump 2 of the fuel supply module M1 sucks the fuel from the fuel tank 1 and guides the fuel through the fuel filter 3 in the high pressure fuel pump 5 of the fuel supply module M1. A pressure between the low pressure fuel pump 2 and the high pressure fuel pump 5 can be between one and ten bar. Hot fuel of pressure control valve 9, injectors 11 and the high pressure fuel pump 5 can be lead or guided to the fuel tank 1 via in particular the main fuel return line 14.

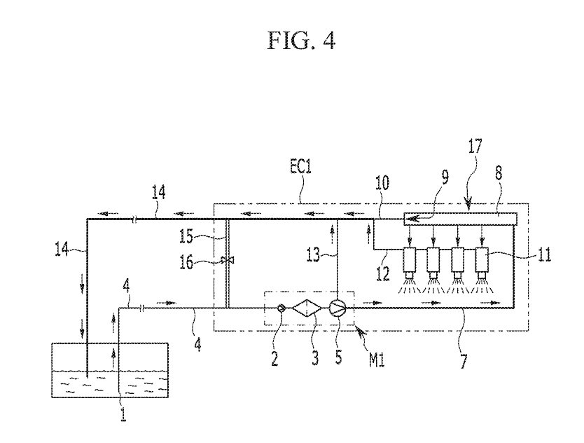

FIG. 4 illustrates a schematic view of a fuel supply module according to a second embodiment of the present disclosure.

FIG. 4 is substantially based on FIG. 3 with the difference that the recirculation valve 16 of the recirculation line 15 is opened, which in particular can be at a fuel temperature equal or below 40° C., for example. Due to compression of the fuel in the high pressure fuel pump 5 and expansion in the injectors 11 the fuel in the corresponding fuel return lines, substantially the first supply line 13, the second supply line 10 and the third supply line 12 and at least partially of the main fuel return line 14, has a higher temperature than in the supply line 4 which is connected, in particular directly connected, with the low pressure fuel pump 2. The heated-up fuel is guided due to the opened recirculation valve 16 and a slight overpressure in the recirculation line 15 compared to the supply line 4 in direction to the low pressure fuel pump 2. Consequently, a temperature in the low pressure fuel pump 2 and the fuel filter 3 can be increased. Therefore, blocking of the fuel filter 3 can be prevented. The fuel temperature in the fuel filter 3 can therefore be higher as heated-up with a state of the art electrical fuel heater H1. Thus, the fuel filter 3 of the fuel supply module M1 can be protected against bad fuel quality as well as low cold filter plugging point (CFPP).

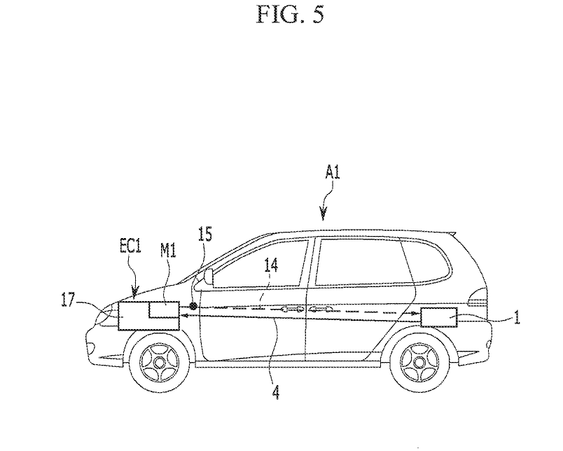

FIG. 5 illustrates a schematic cross-sectional view of a vehicle with a fuel supply module according to FIG. 3 or FIG. 4.

The vehicle A1 as shown in FIG. 5 illustrates that the fuel supply module M1 can be configured to be mounted, arranged or positioned in the engine compartment EC1 with the combustion engine 17. Further, a simplified representation of the supply line 4 and the main fuel return line 14 are illustrated. The supply line 4 and the main fuel return line 14 are connected with the recirculation line 15. It can be seen that the low pressure fuel pump 2 is not positioned in the fuel tank 1 and the low pressure fuel pump 2 is in particular an essential component of the here described fuel supply module M1.

It is understood, that the here disclosed components of the fuel supply module are connected to each other with corresponding supply line as well as the various fuel return lines as illustrated in the corresponding figures.

Although the here afore-mentioned fuel supply module has been described in connection to vehicles, accordingly. For a person skilled in the art it is clearly and unambiguously understood that the here described fuel supply module can be applied to various objects which comprise combustion engines.

What is claimed is:

1. A fuel supply module for a combustion engine comprising:
a low pressure fuel pump;
a fuel filter; and
a high pressure fuel pump,
wherein the low pressure fuel pump, the fuel filter, and the high pressure fuel pump are integral parts of the fuel supply module, and
wherein the fuel filter is arranged between the low pressure fuel pump and the high pressure fuel pump.

2. The fuel supply module according to claim 1, wherein the fuel supply module is mounted in an engine compartment.

3. The fuel supply module according to claim 1, wherein the low pressure fuel pump is connected with a fuel tank via a supply line.

4. The fuel supply module according to claim 3, wherein the high pressure fuel pump is connected with a main fuel return line via a first fuel return line and the main fuel return line is connected with the fuel tank.

5. The fuel supply module according to claim 1, wherein a recirculation line with a recirculation valve is arranged between the supply line and the main fuel return line, and
wherein the recirculation line is arranged ahead of the low pressure fuel pump.

6. The fuel supply module according to claim 5, wherein the recirculation valve is controllable in conjunction with a fuel temperature.

7. The fuel supply module according to claim 6, wherein the recirculation valve is closed at the fuel temperature above 40° C. or the recirculation valve is opened at the fuel temperature equal or below 40° C.

8. The fuel supply module according to claim 1, wherein the fuel supply module is supplied with fuel, and
wherein the fuel is heated up by the combustion engine.

9. The fuel supply module according to claim 1, wherein the high pressure fuel pump is connected with a rail via a high pressure line.

10. The fuel supply module according to claim 9, wherein the rail comprises a second fuel return line which is connected with the main fuel return line.

11. The fuel supply module according to claim 1, wherein at least one injector is connected with the main fuel return line via a third fuel return line.

12. The fuel supply module according to claim 1, wherein the first fuel return line, the second fuel return line and the third fuel return line lead to the main fuel return line.

13. The fuel supply module according to claim 1, wherein the combustion engine includes a diesel combustion engine.

14. A vehicle with a fuel supply module which comprises:
a low pressure fuel pump;
a fuel filter; and
a high pressure fuel pump,
wherein the low pressure fuel pump, the fuel filter, and the high pressure fuel pump are integral parts of the fuel supply module, and
wherein the fuel filter is arranged between the low pressure fuel pump and the high pressure fuel pump.
